(19) United States
(12) Patent Application Publication
(10) Pub. No.: US 2024/0370374 A1
(43) Pub. Date: Nov. 7, 2024

(54) COMPUTER SYSTEM, METHOD FOR COMPUTER SYSTEM, AND READABLE STORAGE MEDIUM

(71) Applicant: Alibaba Innovation Private Limited, Singapore (SG)

(72) Inventors: Jiacheng MA, San Jose, CA (US); Dimin NIU, Sunnyvale, CA (US); Tianchan GUAN, Shanghai (CN); Yijin GUAN, Beijing (CN); Hongzhong ZHENG, Los Gatos, CA (US)

(21) Appl. No.: 18/654,561

(22) Filed: May 3, 2024

(30) Foreign Application Priority Data
May 5, 2023 (CN) 202310511730.7

(51) Int. Cl. G06F 12/0871; G06F 12/0817; G06F 12/1045

(52) U.S. Cl. CPC G06F 12/0871; G06F 12/082; G06F 12/1054

(57) ABSTRACT

The present disclosure relates to a computer system, a method for a computer system, and a computer-readable storage medium for executing the method for a computer system. The method for a computer system includes: using a first central processing unit (CPU) in a first host of the plurality of hosts to send memory request information according to a storage space required for executing a task; using a first cache coherence device in the first host and the switch to forward the memory request information to a second host of the plurality of hosts, so as to request the second host to allocate partial space in a memory to the first CPU for use, wherein the second host includes a second cache coherence device; in response to allocating the partial space in the memory of the second host, using the second cache coherence device and the switch to provide a physical address of the partial space to the first cache coherence device for translation to generate a translated physical address; and accessing the partial space by the first CPU using the translated physical address.

### CROSS-REFERENCE TO RELATED APPLICATIONS

The disclosure claims the benefits of priority to Chinese Application No. 202310511730.7, filed on May 5, 2023, which is incorporated herein by reference in its entirety.

### TECHNICAL FIELD

The present disclosure relates to a computer system, a method for a computer system, and a readable storage medium for executing the method for a computer system, in particular to a computer system capable of enabling a plurality of hosts to share memories, a method for a computer system capable of enabling a plurality of hosts to share memories, and a computer-readable storage medium for executing the method.

### BACKGROUND

With the continuous development of the network technology, the speed of the network is constantly increasing, creating favorable conditions for applications of cluster systems. Cluster systems can provide users with a large number of central processing units (CPUs) and memory resources. However, because each node in a cluster is still an autonomous individual, its memory resources cannot be shared and then cannot be effectively utilized, resulting in serious waste of the memory resources in the cluster.

### SUMMARY

The disclosed embodiments of the present disclosure provide a computer system, a method for a computer system, and a readable storage medium for executing the method for a computer system to solve the above problems.

Some embodiments of the present disclosure provide a method for a computer system, where the computer system includes a plurality of hosts and a switch. The method for a computer system includes: using a first central processing unit (CPU) in a first host of the plurality of hosts to send memory request information according to a storage space required for executing a task; using a first cache coherence device in the first host and the switch to forward the memory request information to a second host of the plurality of hosts, so as to request the second host to allocate partial space in a memory to the first CPU for use, wherein the second host includes a second cache coherence device; in response to allocating the partial space in the memory of the second host, using the second cache coherence device and the switch to provide a physical address of the partial space to the first cache coherence device for translation to generate a translated physical address; and accessing the partial space by the first CPU using the translated physical address.

Some embodiments of the present disclosure provide a computer system, including a plurality of hosts and a switch. A first host of the plurality of hosts includes a first CPU, a first memory and a first cache coherence device. The first memory is communicatively coupled to the first CPU, and the first cache coherence device is communicatively coupled to the first CPU. At least one second host of the plurality of hosts includes a second CPU and a second cache coherence device, and the second cache coherence device is communicatively coupled to the second CPU. The switch is communicatively coupled to the first cache coherence device and the second cache coherence device, where the second CPU sends memory request information according to the storage space required for executing a task, and the memory request information is transmitted to the first host through the second cache coherence device and the switch to request the first memory to allocate a target space to the second CPU for executing the task; the first cache coherence device is used for transmitting a physical address of the target space to the second cache coherence device through the switch, and the second cache coherence device executes address translation to translate the physical address into a translated physical address; and the second CPU accesses the target space through the translated physical address.

Some embodiments of the present disclosure provide a non-transitory computer-readable storage medium storing a set of instructions that are executable by one or more processors of a device to cause the device to execute the method for a computer system as mentioned above.

### BRIEF DESCRIPTION OF THE DRAWINGS

The accompanying drawings described herein are used for providing a further understanding of this disclosure, and form part of this disclosure. Exemplary embodiments of this disclosure and descriptions thereof are used for explaining this disclosure, and do not constitute any inappropriate limitation to this disclosure. It should be noted that according to industry standard practices, various structures are not drawn to scale. In fact, for clear discussion, the sizes of various structures may be increased or reduced arbitrarily. In the accompanying drawings:

FIG. 1 is an architecture diagram of an exemplary computer system according to some embodiments of the present disclosure.

FIG. 2 is a configuration diagram of an exemplary local storage space and an exemplary remote storage space in a first memory and a second memory, according to some embodiments of the present disclosure.

FIG. 3 is a schematic diagram of an exemplary total capacity provided by a first cache coherence device, according to some embodiments of the present disclosure to a first CPU.

FIG. 4 is a flowchart of an exemplary method for a computer system, according to some embodiments of the present disclosure.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the present disclosure. Instead, they are merely examples of apparatuses and methods consistent with aspects related to the present disclosure as recited in the appended claims. Particular aspects of the present disclosure are described in greater detail below. The terms and definitions provided herein control, if in conflict with terms or definitions incorporated by reference.

In general, a computer system usually includes a plurality of interconnected hosts, and each host may include a memory. When a task is executed, a storage space sharing mechanism is adopted to allocate the specific or idle storage space in a host to the host executing the task. After the task is completed, the storage space is released, and then, the computer system continues to allocate the storage space to other tasks with storage requirements. In this way, each host in the computer system does not need to be equipped with a memory with an extremely large capacity, so that the cost and size can be reduced.

In the present disclosure, cache coherence devices configured in the host executing a task are responsible for managing the application and address mapping of the remote storage space to reduce the workload of the CPU executing the task in the host. According to some embodiments of the present disclosure, the first cache coherence device and second cache coherence device in the computer system communicate with each other through the switch, thus the utilization efficiency of memory resources are improved.

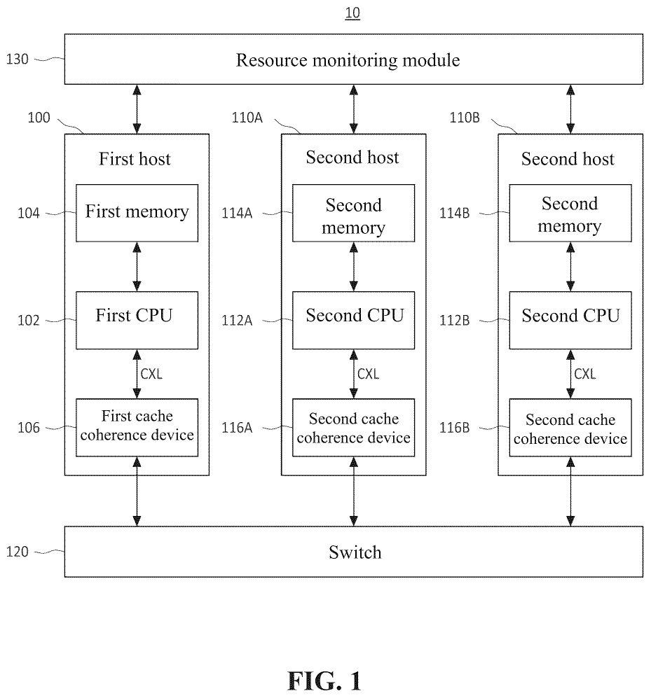

FIG. 1 is an architecture diagram of an exemplary computer system 10 according to some embodiments of the present disclosure. A computer system 10 includes a first host 100, a plurality of second hosts (such as second hosts 110A and 110B shown in FIG. 1), and a switch 120. First host 100 communicates with second hosts 110A and 110B through switch 120. In some embodiments, first host 100 and second hosts 110A and 110B are located in a single rack, and switch 120 may be a top-of-rack (TOR) switch to minimize communication paths between first host 100, second hosts 110A and 110B and switch 120, thus reducing the communication delay. Computer system 10 including three groups of hosts, as shown in FIG. 1, is taken as an example for description. However, in some embodiments, switch 120 can be used for scaling computer system 10 to a larger size, for example, having a larger number of hosts, and the number of hosts included in computer system 10 may depend on the size of the rack (such as height) and the power supply capacity of a rack power module. In other embodiments, a plurality of hosts connected together through switch 120 may be configured in different racks, so that the resources used by computer system 10 for executing computer programs are dynamically extensible. The above-mentioned computer programs may be a set of ordered instructions (such as arithmetic, logic, control and input/output operations) executed by computer system 10 for specific tasks.

Switch 120 may be a network switch or a switch supporting the cache coherence interconnection protocol, such as a compute express link (CXL) switch. The CXL switch can provide better throughput and delay performance than the network switch, and the network switch can provide long-distance transmission. Therefore, compared to the CXL switch, the network switch is more suitable for application in embodiments where a plurality of hosts are configured in different racks.

First host 100 includes a first central processing unit (CPU) 102, a first memory 104 and a first cache coherence device 106. First memory 104 and first cache coherence device 106 are respectively connected to first CPU 102. First CPU 102 may include an electronic circuit for executing a computer program.

First memory 104 is connected to first CPU 102 for storing instructions and data needing to be processed during computer program execution, and data for implementing instructions. First memory 104 may include a specific number of storage positions, and each storage position has a permanently assigned physical address. First CPU 102 can access the corresponding storage position using the physical address (that is, write data in the storage position specified by the physical address, or read data from the storage position specified by the physical address). First memory 104 may include a volatile memory, such as a random access memory (RAM), or other types of memories capable of storing data. First CPU 102 can access first memory 104 through a memory interface (such as a DDR). In some embodiments, first CPU 102 can access first memory 104 through a device interface, such as a peripheral component interconnect express (PCIe) interface.

First cache coherence device 106 can be configured as a device operated according to the CXL protocol. First cache coherence device 106 can be in accordance with CXL1.1 specifications or CXL2.0 specifications. In some embodiments, first cache coherence device 106 can be configured to be in accordance with CXL specifications of future versions, CXL specifications of modified variants, or any other suitable cache coherence interconnection protocols. First cache coherence device 106 is coupled to first CPU 102, and first CPU 102 and first cache coherence device 106 can communicate according to the CXL protocol. That is, first CPU 102 sends information according to the CXL protocol, and first cache coherence device 106 can recognize the information sent by first CPU 102 according to the CXL protocol, thus achieving the effects of reducing the data transmission delay and increasing the data throughput.

First cache coherence device 106 can be further coupled to switch 120, and switch 120 can determine where to route the information from the information sent by first CPU 102 and transmitted through first cache coherence device 106. In a case that switch 120 is a network switch, first cache coherence device 106 and switch 120 communicate with each other using a network protocol based on Ethernet and the like. Therefore, first cache coherence device 106 is used for converting the information sent from first CPU 102 and following the format specified by the CXL protocol into a format that can be recognized and forwarded by the network switch 120, so as to ensure that the information transmitted through different protocols is not lost even if executing format conversion may result in substantial delay in information transmission. In a case that switch 120 is a CXL switch, switch 120 is configured as an assembly operated according to the CXL protocol. Because the information sent by first CPU 102 in a specific format in accordance with the CXL protocol can be recognized by switch 120 for information forwarding, first cache coherence device 106 does not need to execute format conversion of the information.

Second host 110A includes a second CPU 112A, a second memory 114A and a second cache coherence device 116A. Second memory 114A is connected to second CPU 112A, and second cache coherence device 116A is connected to second CPU 112A and switch 120. Second host 110B includes a second CPU 112B, a second memory 114B and a second cache coherence device 116B. Second memory 114B is connected to second CPU 112B, and second cache coherence device 116B is connected to second CPU 112B and switch 120. First CPU 102 and the second CPUs 112A and 112B may be CPUs of the same model, or CPUs of different models with the same computing capability, so as to ensure that identical computation results can be provided for tasks with the same execution logic.

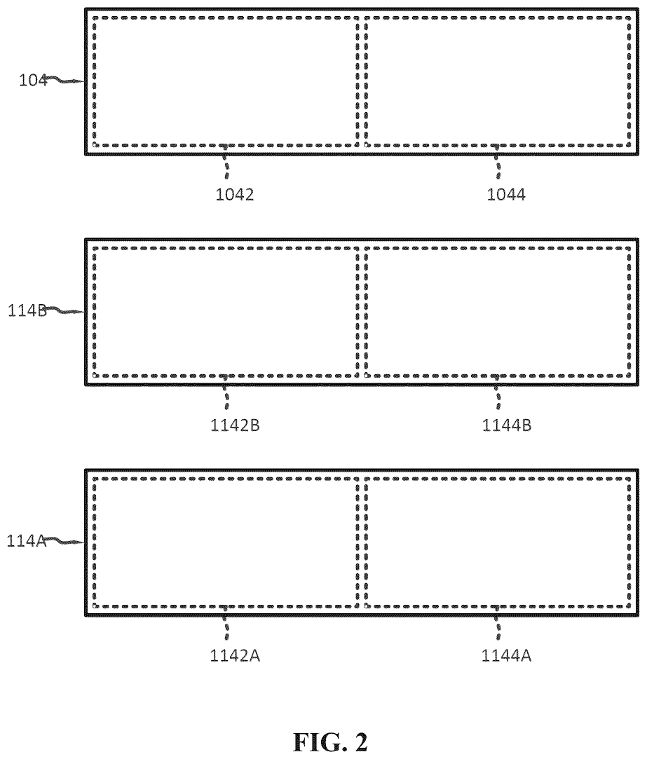

First memory 104 and second memories 114A and 114B may be memories of the same type. The storage space in first memory 104 can be divided into two parts in advance: a local storage space 1042 and a remote storage space 1044, as shown in FIG. 2. Specifically, local storage space 1042 is a dedicated storage space for first CPU 102 for storing instructions and data needing to be processed during the execution of computer programs by first CPU 102, and data for implementing instructions. Remote storage space 1044 can be used for storing instructions and data needing to be processed during the execution of computer programs by the second CPUs 112A or 112B, and data for implementing instructions. In other words, first memory 104 will not configure a permission for accessing remote storage space 1044 for first CPU 102, therefore, first CPU 102 cannot access remote storage space 1044. In some embodiments, first memory 104 can be configured to not perform any action when first CPU 102 performs a write operation on remote storage space 1044, and to return data 0 as a response when first CPU 102 performs a read operation on remote storage space 1044.

Similarly, the storage space of second memory 114A can be divided into a local storage space 1142A and a remote storage space 1144A. Local storage space 1142A is a dedicated storage space for second CPU 112A. Remote storage space 1144A is a storage space provided to one or more CPUs (such as first CPU 102 or second CPU 112B) that do not belong to second host 110A. The storage space of second memory 114B can also be divided into a local storage space 1142B dedicated to second CPU 112B, and a remote storage space 1144B provided to one or more CPUs (such as first CPU 102 or second CPU 112A) except for second CPU 112B.

Referring back to FIG. 1, first cache coherence device 106 and second cache coherence devices 116A and 116B may be devices based on a memory mapping input/output (MMIO) interface, which are used for establishing cache coherence between first memory 104 and second memories 114A and 114B. In some embodiments, first cache coherence device 106 can be configured to at least expose a part of the storage space of first memory 104 to second hosts 110A and 110B, as well as control the access to remote memories (namely second memories 114A and 114B) based on the (memory) access request sent by first CPU 102.

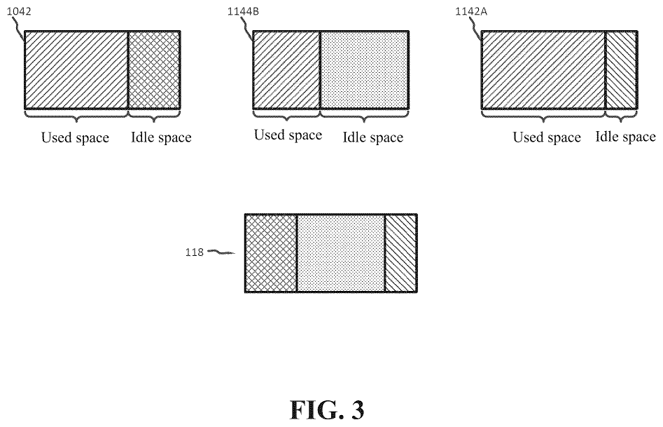

Specifically, first cache coherence device 106 is configured to at least expose the real-time capacity of the idle space in remote storage space 1044 (namely the storage space which is not allocated to any CPU in computer system 10) to second hosts 110A and 110B when first host 100 communicates with second hosts 110A and 110B through switch 120. At the same time, second cache coherence device 116A can expose the real-time capacity of the idle space in remote storage space 1144A in second memory 114A to first host 100 and second host 110B, and second cache coherence device 116B can expose the real-time capacity of the idle space in remote storage space 1144B in second memory 114B to first host 100 and second host 110A. First cache coherence device 106 can be configured to provide the sum of the capacities of the idle spaces in local storage space 1042 and the remote storage spaces 1144A and 1144B as a total capacity 118 (as shown in FIG. 3) to first CPU 102 after obtaining the capacities of the idle spaces in the remote storage spaces 1144A and 1144B exposed by second cache coherence devices 116A and 116B. Referring to FIG. 1 and FIG. 2, similarly, second cache coherence device 116A can be configured to expose the sum of the capacities of the idle spaces in local storage space 1142A and the remote storage spaces 1044 and 1144B to second CPU 112A, and second cache coherence device 116B can be configured to expose the sum of the capacities of the idle spaces in local storage space 1142B and the remote storage spaces 1044 and 1144A to second CPU 112B.

Referring to FIG. 1 and FIG. 2, in some embodiments, computer system 10 further includes a resource monitoring module 130 coupled to first host 100 and second hosts 110A and 110B. Resource monitoring module 130 can be used for detecting the use conditions of first memory 104 and second memories 114A and 114B in real time, such as the use capacities of local storage spaces 1042, 1142A and 1142B and the remote storage spaces 1044, 1144A and 1144B, and providing detection results to the corresponding first cache coherence device 106 and second cache coherence devices 116A and 116B. First cache coherence device 106 and second cache coherence devices 116A and 116B can expose the real-time capacities of the idle spaces to remote hosts according to the detection results sent by resource monitoring module 130.

When first host 100 obtains a computer program, first CPU 102 can analyze the computer program to evaluate the capacity of the storage space occupied for executing the computer program (hereinafter referred to as an occupied capacity), and send a storage application request according to the occupied capacity. The storage application request will be transmitted to first memory 104 and first cache coherence device 106. First memory 104 responds to a reply provided by the storage application request to indicate whether local storage space 1042 includes a sufficient idle space to meet the occupied capacity indicated by the storage application request. In some embodiments, before first CPU 102 obtains a reply from first memory 104, first cache coherence device 106 may not perform any action. First CPU 102 can copy or move the reply from first memory 104 to first cache coherence device 106, so that first cache coherence device 106 can determine whether to send a storage allocation request to second hosts 110A and 110B. When the capacity of the idle space in local storage space 1042 is greater than or equal to the above occupied capacity, first CPU 102 executes the computer program by accessing local storage space 1042, thus reducing the access delay to increase the task execution speed. In this case, first cache coherence device 106 will not send the storage allocation request to second hosts 110A and 110B.

First cache coherence device 106 can be configured to send a storage allocation request for configuring an access permission for the remote storage spaces 1144A and 1144B to second hosts 110A and 110B through switch 120 when the above occupied capacity is greater than the capacity of the idle space in local storage space 1042 in first memory 104. In some embodiments, first cache coherence device 106 can compare the occupied capacity with the capacity of the idle space in local storage space 1042 in first memory 104. When the occupied capacity is greater than the capacity of the idle space in local storage space 1042, first cache coherence device 106 can use the difference obtained by subtracting the capacity of the idle space from the occupied capacity as a supplemental capacity, and send a storage allocation request carrying the supplemental capacity to second hosts 110A and 110B.

Second cache coherence devices 116A and 116B receive the storage allocation request and provide a reply in response to the storage allocation request. The reply may include an indication of whether the remote storage spaces 1144A and 1144B in second memories 114A and 114B include sufficient idle spaces to meet the supplemental capacity for the storage allocation request.

In some embodiments, each of first memory 104 and second memories 114A and 114B can be configured to configure an access permission for the CPU executing a remote access when the capacities of the idle spaces in the remote storage spaces 1044, 1144A and 1144B are greater than or equal to the above supplemental capacity. For example, in a case that the capacity of the idle space in remote storage space 1144A in second memory 114A is less than the above supplemental capacity and the capacity of the idle space in remote storage space 1144B in second memory 114B is greater than or equal to the above supplemental capacity, second host 110A will not configure an access permission for second memory 114A to first CPU 102, and second host 110B will configure an access permission for at least a part of the idle space (hereinafter referred to as a specific space) in remote storage space 1144B in second memory 114B to first CPU 102 according to the supplemental capacity, so that the specific space allows first CPU 102 to perform read and write operations. Therefore, the reply provided by second cache coherence device 116A to first cache coherence device 106 will include allocation request failure, and the reply provided by second cache coherence device 116B to first cache coherence device 106 may include allocation request success and the physical address of each storage position in the specific space.

First cache coherence device 106 can be configured to execute an address translation operation, that is, translate the physical addresses of all storage positions in the specific space, transmitted by second cache coherence device 116A (if there is sufficient idle space in remote storage space 1144A to meet the supplemental capacity indicated by the storage allocation request), or the physical addresses of all storage positions in the specific space, transmitted by second cache coherence device 116B, into translated physical addresses that can be processed by first CPU 102, and an address mapping table can be used for maintaining the mapping information from the translated physical addresses to the physical addresses. The physical address of the specific space, provided by second memory 114A or 114B to first CPU 102, may be discontinuous, but the translated address can be guaranteed to have continuity through address translation. First cache coherence device 106 can also be configured to maintain the address continuity in the storage space in first memory 104 and the specific space. That is to say, the start address of the translated physical address used in the specific space follows the end address of the physical address in the storage space in first memory 104.

During the execution of a computer program, first CPU 102 can preferentially store data in the idle space of local storage space 1042. When local storage space 1042 is full, the data that is not stored in local storage space 1042 is stored in remote storage space 1144A or 1144B. That is to say, when first CPU 102 makes a storage allocation request, computer system 10 uses a memory allocation method similar to a non-uniform memory access (NUMA) architecture to allocate a storage space. Under this architecture, several CPUs are connected to a memory through a memory bus to form a node, and the entire system is divided into several nodes. The memory located in one node is referred to as a local memory, and the memory located in other nodes is referred to as a remote memory relative to the node. When allocating a storage space for a computer program running on a CPU, computer system 10 usually performs an allocation operation from a local memory of the CPU rather than a remote memory, thus providing data access performance.

First cache coherence device 106 can judge whether first CPU 102 needs to access local storage space 1042 or remote storage space 1144A or 1144B based on address range checking. When first cache coherence device 106 obtains a translated physical address in an access request sent by first CPU 102, the translated physical address can be converted into a physical address for accessing second memory 114A or 114B by referring to the address mapping table, and the physical address is relayed to the corresponding second cache coherence device 116A or 116B through switch 120 to execute the access to remote storage space 1144A or 1144B. During the execution of a computer program by first CPU 102, first cache coherence device 106 and second cache coherence devices 116A and 116B continuously monitor the data read and write operations executed by first CPU 102, thereby establishing cache coherence. For example, when first CPU 102 executes a data write operation at an address in remote storage space 1144B in second memory 114B, first cache coherence device 106 can communicate with second cache coherence devices 116A and 116B through switch 120, so that the data stored by second CPU 112A at the address in the corresponding remote storage space 1144B is invalid. The operation of second cache coherence devices 116A and 116B is basically the same as that of first cache coherence device 106, and will not be repeated here.

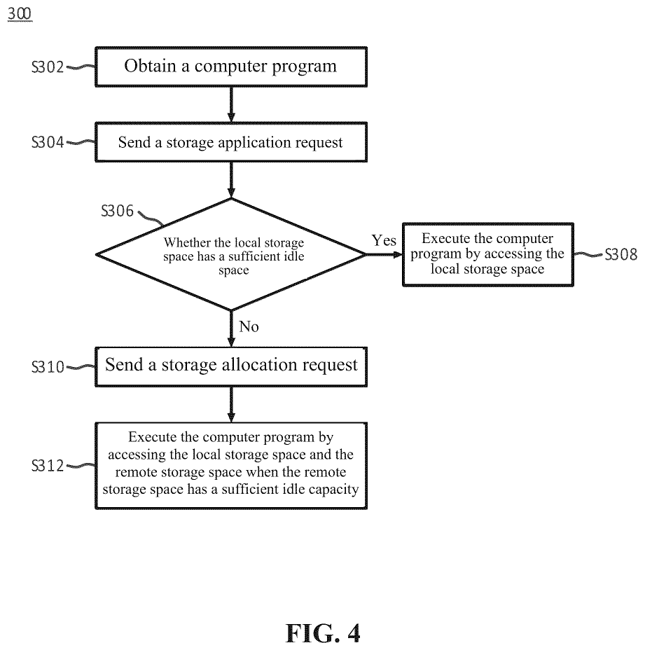

FIG. 4 is a flowchart of an exemplary method 300 for a computer system, according to some embodiments of the present disclosure. Referring to FIG. 1 and FIG. 4, method 300 may include the following steps S302 to S312, which can be implemented by a computer system (e.g., computer system 10 shown in FIG. 1). Method 300 for a computer system can start from step S302 in which first host 100 in computer system 10 obtains a computer program. The CPU 102 in first host 100 can send a storage request to first memory 104 and first cache coherence device 106 according to the occupied capacity indicated by the message of the computer program in step S304. Then, in step S306, first memory 104 can compare the occupied capacity with the capacity of the idle space in local storage space 1042 to judge whether there is sufficient idle space in local storage space 1042 to meet the occupied capacity indicated by the storage allocation request.

When it is decided that local storage space 1042 in first memory 104 has sufficient idle space in step S306 (that is, the capacity of the idle space in local storage space 1042 is greater than or equal to the occupied capacity), first CPU 102 executes the computer program by accessing local storage space 1042 in step S308. When it is decided that local storage space 1042 does not have sufficient idle space in step S306 (that is, the capacity of the idle space in local storage space 1042 is less than the occupied capacity), first cache coherence device 106 sends the storage allocation request to at least one second host 110A or 110B in computer system 10 through switch 120 in step S310. In some embodiments, first cache coherence device 106 can compare the occupied capacity with the capacity of the idle space in local storage space 1042, use the difference obtained by subtracting the capacity of the idle space from the occupied capacity as a supplemental capacity when the occupied capacity is greater than the capacity of the idle space in local storage space 1042, and send a storage allocation request carrying information of the supplemental capacity to second hosts 110A and 110B.

Continuing with step S310, when it is decided that the capacity of the idle space in remote storage space 1144A or 1144B in second memory 114A or 114B is greater than or equal to the supplemental capacity, first CPU 102 can execute the computer program by accessing local storage space 1042 and remote storage space 1144A or 1144B in step S312.

It is appreciated that all or some processes in the methods in the above embodiments can be implemented by computer programs and instructions to indicate and command related hardware. The computer programs can be stored in a computer-readable storage medium. The processes of the method for a computer system as mentioned above may be included when the computer programs and instructions are executed.

In some embodiments, first host 100 and second hosts 110A and 110B further include memories, processors and computer programs stored in the memories and capable of running on the processors. The processor and the memory may be connected by a bus or in other ways. The memory, as a non-transient computer-readable storage medium, can be configured to store non-transient software programs and non-transient computer executable programs. The memory may include a high-speed random access memory, and may further include a non-transient memory, such as at least one magnetic disk storage device, a flash memory device, or other non-transient solid-state storage devices. In some implementations, the memory includes memories remotely arranged relative to the processor, and these remote memories may be connected to the processor through a network. The examples of the above network include but are not limited to the Internet, Intranet, local area networks, mobile communication networks, and combinations thereof.

Some embodiments of the present disclosure provide a non-transient software program and instruction required for implementing method 300 for a computer system stored in the memory. When the program and instruction are executed by the processor, step S302 to step S312 shown in FIG. 4 can be executed.

In some embodiments, first CPU 102 and the second CPUs 112A and 112B can execute various functional applications and data processing by executing computer programs stored in first memory 104 and second memories 114A and 114B, for example, implementing method 300 for a computer system provided in the embodiments of the present disclosure.

In addition, some embodiments of the present disclosure further provide a computer-readable storage medium. The computer-readable storage medium stores a computer executable instruction. The computer executable instruction may be executed by a processor or controller, for example, by first CPU 102 and the second CPUs 112A or 112B in computer system 10. First CPU 102 and the second CPUs 112A or 112B can execute method 300 for a computer system in the above embodiments, for example, execute step S302 to step S312 of method 300 in FIG. 4 as described above.

It is appreciated that all or some of the steps and systems in method 300 for a computer system disclosed above may be implemented as software, firmware, hardware, and appropriate combinations thereof. Some physical assemblies or all physical assemblies may be implemented as software executed by a processor, such as a central processing unit, a digital signal processor or a microprocessor, or implemented as hardware, or implemented as an integrated circuit, such as an application specific integrated circuit. Such software may be distributed on a computer-readable medium, and the computer-readable medium may include a computer storage medium (or non-temporary medium) and a communication medium (or temporary medium). As can be appreciated, the term computer storage medium includes volatile and non-volatile as well as removable and non-removable media implemented in any method or technology for storing information (such as computer-readable instructions, data structures, program modules or other data). The computer storage medium includes but is not limited to a random access memory (RAM), a read-only memory (ROM), an electrically erasable programmable read-only memory (EEPROM), a flash memory or other memory technologies, a compact disc read-only memory (CD-ROM), a digital video disk (DVD) or other optical disc memories, a magnetic case, a magnetic tape, a magnetic disk memory or other magnetic storage devices, or any other medium that can be used for storing desired information and can be accessed by computers. In addition, it is appreciated that the communication medium usually includes a computer-readable instruction, a data structure, a program module or other data in modulated data signals such as carriers or other transmission mechanisms, and may include any information delivery medium.

The embodiments may further be described using the following clauses:
1. A method for a computer system having a plurality of hosts and a switch, including:
using a first central processing unit (CPU) in a first host of the plurality of hosts to send memory request information according to a storage space required for executing a task;
using a first cache coherence device in the first host and the switch to forward the memory request information to a second host of the plurality of hosts, so as to request the second host to allocate partial space in a memory to the first CPU for use, wherein the second host includes a second cache coherence device;
in response to allocating the partial space in the memory of the second host, using the second cache coherence device and the switch to provide a physical address of the partial space to the first cache coherence device for translation to generate a translated physical address; and
accessing the partial space by the first CPU using the translated physical address.
2. The method according to clause 1, wherein in response to the first CPU using the translated physical address to access the partial space by the first cache coherence device, transmitting the physical address mapped to the translated physical address to the second host through the switch, wherein the first cache coherence device records mapping information of the physical address and the translated physical address.
3. The method according to clause 1 or 2, wherein the first cache coherence device, the second cache coherence device and the switch communicate with each other through a cache coherence interconnection protocol.
4. The method according to any of clauses 1 to 3, wherein the first cache coherence device is configured to translate the memory request information sent by the first CPU in accordance with a first protocol into memory request information in accordance with a second protocol and to send the memory request information in accordance with the second protocol to the switch;
wherein the second cache coherence device is configured to translate the memory request information transmitted by the switch in accordance with the second protocol into memory request information in accordance with the first protocol and to send the memory request information in accordance with the first protocol to a second CPU, and
wherein the first protocol is in accordance with protocol provisions of a cache coherence interconnection protocol, and the second protocol is in accordance with the protocol provisions of a network protocol.
5. The method according to any of clauses 1 to 4, wherein the computer system further includes a resource monitoring module communicatively coupled to the memory, and the method further includes:
monitoring a use state of the memory, and providing a monitoring result to the first cache coherence device.
6. A computer system, including:
a first host, including:
   a first CPU;
   a first memory communicatively coupled to the first CPU; and
   a first cache coherence device communicatively coupled to the first CPU;
a second host, including:
   a second CPU; and
   a second cache coherence device communicatively coupled to the second CPU; and
a switch communicatively coupled to the first cache coherence device and the second cache coherence device,
wherein the second CPU is configured to send memory request information according to a storage space required for executing a task, and the memory request information is transmitted to the first host through the second cache coherence device and the switch to request the first memory to allocate a target space to the second CPU for executing the task;
wherein the first cache coherence device is configured to transmit a physical address of the target space to the second cache coherence device through the switch, and the second cache coherence device is configured to execute address translation to translate the physical address into a translated physical address; and
wherein the second CPU is further configured to access the target space through the translated physical address.
7. The computer system according to clause 6, wherein in response to the first host and the second host establishing a communication through the switch, the first cache coherence device is further configured to expose a partial space in the first memory to the second CPU for use by the second CPU, wherein the partial space includes the target space.
8. The computer system according to clause 7, wherein:
the first memory includes a local storage space and a remote storage space; and
in response to the first cache coherence device and the second cache coherence device establishing a communication through the switch, the first cache coherence device is further configured to expose a residual space of the remote storage space to the second cache coherence device.
9. The computer system according to clause 8, wherein:
the second host further includes a second memory, and in response to the storage space required for executing a task by the second CPU being less than the residual space of the second memory, the second cache coherence device is further configured to request the target space from the first memory through the switch and the first cache coherence device.
10. The computer system according to clause 9, further including a resource monitoring module, communicatively coupled to the first memory and the second memory, and configured to monitor a use state of the second memory, the local storage space and the remote storage space and provide detection results to the first cache coherence device and the second cache coherence device.
11. The computer system according to clause 9, wherein the second cache coherence device is further configured to record mapping information of the physical address and the translated physical address, and the translated physical address used in the target space follows the physical address of the storage space of the second memory.
12. The computer system according to clause 6, wherein the switch includes a compute express link (CXL) switch or a network switch.
13. The computer system according to clause 6, wherein:
the second cache coherence device is configured to receive the memory request information in accordance with a first protocol, convert the memory request information in accordance with the first protocol into memory request information in accordance with a second protocol, and to send the memory request information in accordance with the second protocol to the switch; and
the first cache coherence device is configured to receive the memory request information in accordance with the second protocol from the switch, convert the memory request information in accordance with the second protocol into memory request information in accordance with the first protocol, and to send the memory request information in accordance with the first protocol to the first CPU,
wherein the first protocol is a cache coherence interconnection protocol, and the second protocol is a network protocol.
14. A non-transitory computer-readable storage medium storing a set of instructions that are executable by one or more processors of a device to cause the device to perform operations for a computer system having a plurality of hosts and a switch, the operations including:
using a first central processing unit (CPU) in a first host of the plurality of hosts to send memory request information according to a storage space required for executing a task;
using a first cache coherence device in the first host and the switch to forward the memory request information to a second host of the plurality of hosts, so as to request the second host to allocate partial space in a memory to the first CPU for use, wherein the second host includes a second cache coherence device;
in response to allocating the partial space in the memory of the second host, using the second cache coherence device and the switch to provide a physical address of the partial space to the first cache coherence device for translation to generate a translated physical address; and
accessing the partial space by the first CPU using the translated physical address.
15. The non-transitory computer-readable storage medium according to clause 14, wherein in response to the first CPU using the translated physical address to access the partial space by the first cache coherence device, transmitting the physical address mapped to the translated physical address to the second host through the switch, wherein the first cache coherence device records mapping information of the physical address and the translated physical address.
16. The non-transitory computer-readable storage medium according to clause 14 or 15, wherein the first cache coherence device, the second cache coherence device and the switch communicate with each other through a cache coherence interconnection protocol.
17. The non-transitory computer-readable storage medium according to any of clauses 14 to 16, wherein the first cache coherence device is configured to translate the memory request information sent by the first CPU in accordance with a first protocol into memory request information in accordance with a second protocol, and to send the memory request information in accordance with the second protocol to the switch;
wherein the second cache coherence device is configured to translate the memory request information transmitted by the switch in accordance with the second protocol into memory request information in accordance with the first protocol, and to send the memory request information in accordance with the first protocol to a second CPU, and
wherein the first protocol is in accordance with protocol provisions of a cache coherence interconnection protocol, and the second protocol is in accordance with the protocol provisions of a network protocol.
18. The non-transitory computer-readable storage medium according to any of clauses 14 to 17, wherein the computer system further includes a resource monitoring module communicatively coupled to the memory, and the operations further include:
monitoring a use state of the memory, and providing a monitoring result to the first cache coherence device.

As used herein, the case that a first component is formed above or on a second component may include embodiments in which the first component and the second component are in direct contact, and may further include embodiments in which an additional component can be formed between the first component and the second component so that the first component and the second component cannot be in direct contact. In addition, the disclosure may repeat reference numbers and/or letters in various examples. This repetition is for the purposes of simplicity and clarity, and does not indicate the relationship between various embodiments or configurations discussed.

As used herein, terms such as “first” and “second” describe various assemblies, components, regions, layers and/or sections, but such assemblies, components, regions, layers and/or sections should not be restricted by such terms. This type of terms can only be used for distinguishing one assembly, component, region, layer or section from each other. For example, the terms such as “first” and “second” when used herein do not imply a sequence or an order, unless explicitly indicated by the background content.

The singular forms “a/an”, “one” and “the” may also include a plural form, unless otherwise specified by the context. The term “connection” and derivatives thereof can be used herein to describe the structural relationship between components. The “connection” can be used for describing two or more assemblies that are in direct physical or electrical contact with each other. The “connection” can also be used for indicating direct or indirect physical or electrical contact between two or more assemblies (with intervening assemblies between them), and/or the cooperation or interaction between the two or more assemblies.

The foregoing descriptions are merely preferred implementations of the present disclosure. It is to be noted that a plurality of improvements and refinements may be made by those of ordinary skill in the technical field without departing from the principle of the present disclosure, and shall fall within the scope of protection of the present disclosure.

In the drawings and specification, there have been disclosed exemplary embodiments. However, many variations and modifications can be made to these embodiments. Accordingly, although specific terms are employed, they are used in a generic and descriptive sense only and not for purposes of limitation.

What is claimed is:

1. A method for a computer system having a plurality of hosts and a switch, comprising:
using a first central processing unit (CPU) in a first host of the plurality of hosts to send memory request information according to a storage space required for executing a task;
using a first cache coherence device in the first host and the switch to forward the memory request information to a second host of the plurality of hosts, so as to request the second host to allocate partial space in a memory to the first CPU for use, wherein the second host comprises a second cache coherence device;
in response to allocating the partial space in the memory of the second host, using the second cache coherence device and the switch to provide a physical address of the partial space to the first cache coherence device for translation to generate a translated physical address; and
accessing the partial space by the first CPU using the translated physical address.

2. The method according to claim 1, wherein in response to the first CPU using the translated physical address to access the partial space by the first cache coherence device, transmitting the physical address mapped to the translated physical address to the second host through the switch, wherein the first cache coherence device records mapping information of the physical address and the translated physical address.

3. The method according to claim 1, wherein the first cache coherence device, the second cache coherence device and the switch communicate with each other through a cache coherence interconnection protocol.

4. The method according to claim 1, wherein the first cache coherence device is configured to translate the memory request information sent by the first CPU in accordance with a first protocol into memory request information in accordance with a second protocol and to send the memory request information in accordance with the second protocol to the switch;
wherein the second cache coherence device is configured to translate the memory request information transmitted by the switch in accordance with the second protocol into memory request information in accordance with the first protocol and to send the memory request information in accordance with the first protocol to a second CPU, and
wherein the first protocol is in accordance with protocol provisions of a cache coherence interconnection protocol, and the second protocol is in accordance with the protocol provisions of a network protocol.

5. The method according to claim 1, wherein the computer system further comprises a resource monitoring module communicatively coupled to the memory, and the method further comprises:
monitoring a use state of the memory, and providing a monitoring result to the first cache coherence device.

6. A computer system, comprising:
a first host, comprising:
a first CPU;
a first memory communicatively coupled to the first CPU; and
a first cache coherence device communicatively coupled to the first CPU;
a second host, comprising:
a second CPU; and
a second cache coherence device communicatively coupled to the second CPU; and
a switch communicatively coupled to the first cache coherence device and the second cache coherence device,
wherein the second CPU is configured to send memory request information according to a storage space required for executing a task, and the memory request information is transmitted to the first host through the second cache coherence device and the switch to request the first memory to allocate a target space to the second CPU for executing the task;
wherein the first cache coherence device is configured to transmit a physical address of the target space to the second cache coherence device through the switch, and the second cache coherence device is configured to execute address translation to translate the physical address into a translated physical address; and
wherein the second CPU is further configured to access the target space through the translated physical address.

7. The computer system according to claim 6, wherein in response to the first host and the second host establishing a communication through the switch, the first cache coherence device is further configured to expose a partial space in the first memory to the second CPU for use by the second CPU, wherein the partial space comprises the target space.

8. The computer system according to claim 7, wherein:
the first memory comprises a local storage space and a remote storage space; and
in response to the first cache coherence device and the second cache coherence device establishing a communication through the switch, the first cache coherence device is further configured to expose a residual space of the remote storage space to the second cache coherence device.

9. The computer system according to claim 8, wherein:
the second host further comprises a second memory, and in response to the storage space required for executing a task by the second CPU being less than the residual space of the second memory, the second cache coherence device is further configured to request the target space from the first memory through the switch and the first cache coherence device.

10. The computer system according to claim 9, further comprising a resource monitoring module, communicatively coupled to the first memory and the second memory, and configured to monitor a use state of the second memory, the local storage space and the remote storage space and provide detection results to the first cache coherence device and the second cache coherence device.

11. The computer system according to claim 9, wherein the second cache coherence device is further configured to record mapping information of the physical address and the translated physical address, and the translated physical address used in the target space follows the physical address of the storage space of the second memory.

12. The computer system according to claim 6, wherein the switch comprises a compute express link (CXL) switch or a network switch.

13. The computer system according to claim 6, wherein:
the second cache coherence device is configured to receive the memory request information in accordance with a first protocol, convert the memory request information in accordance with the first protocol into memory request information in accordance with a second protocol, and to send the memory request information in accordance with the second protocol to the switch; and
the first cache coherence device is configured to receive the memory request information in accordance with the second protocol from the switch, convert the memory request information in accordance with the second protocol into memory request information in accordance with the first protocol, and to send the memory request information in accordance with the first protocol to the first CPU,
wherein the first protocol is a cache coherence interconnection protocol, and the second protocol is a network protocol.

14. A non-transitory computer-readable storage medium storing a set of instructions that are executable by one or more processors of a device to cause the device to perform operations for a computer system having a plurality of hosts and a switch, the operations comprising:
using a first central processing unit (CPU) in a first host of the plurality of hosts to send memory request information according to a storage space required for executing a task;
using a first cache coherence device in the first host and the switch to forward the memory request information to a second host of the plurality of hosts, so as to request the second host to allocate partial space in a memory to the first CPU for use, wherein the second host comprises a second cache coherence device;
in response to allocating the partial space in the memory of the second host, using the second cache coherence device and the switch to provide a physical address of the partial space to the first cache coherence device for translation to generate a translated physical address; and
accessing the partial space by the first CPU using the translated physical address.

15. The non-transitory computer-readable storage medium according to claim 14, wherein in response to the first CPU using the translated physical address to access the partial space by the first cache coherence device, transmitting the physical address mapped to the translated physical address to the second host through the switch, wherein the first cache coherence device records mapping information of the physical address and the translated physical address.

16. The non-transitory computer-readable storage medium according to claim 14, wherein the first cache coherence device, the second cache coherence device and the switch communicate with each other through a cache coherence interconnection protocol.

17. The non-transitory computer-readable storage medium according to claim 14, wherein the first cache coherence device is configured to translate the memory request information sent by the first CPU in accordance with a first protocol into memory request information in accordance with a second protocol, and to send the memory request information in accordance with the second protocol to the switch;
wherein the second cache coherence device is configured to translate the memory request information transmitted by the switch in accordance with the second protocol into memory request information in accordance with the first protocol, and to send the memory request information in accordance with the first protocol to a second CPU, and
wherein the first protocol is in accordance with protocol provisions of a cache coherence interconnection protocol, and the second protocol is in accordance with the protocol provisions of a network protocol.

18. The non-transitory computer-readable storage medium according to claim 14, wherein the computer system further comprises a resource monitoring module communicatively coupled to the memory, and the operations further comprise:
monitoring a use state of the memory, and providing a monitoring result to the first cache coherence device.
